(19) United States
(12) Patent Application Publication
(10) Pub. No.: US 2021/0100266 A1
(43) Pub. Date: Apr. 8, 2021

(54) ENERGY SUPPLEMENT COMPOSITIONS

(71) Applicant: Phoenix Energy LLC, Boise, ID (US)

(72) Inventor: Jordan Reed Kepler, Meridian, ID (US)

(21) Appl. No.: 17/061,027

(22) Filed: Oct. 1, 2020

Related U.S. Application Data
(60) Provisional application No. 62/910,121, filed on Oct. 3, 2019.

(51) Int. Cl. A23L 2/52; A23L 2/395; A23L 33/175; A23L 33/15; A23L 29/00

(52) U.S. Cl. CPC A23L 2/52; A23L 2/395; A23L 29/035; A23L 33/15; A23L 33/175

(57) ABSTRACT

An energy supplement composition, such as a small-volume “shot” drink, comprises ingredients formulated to enhance not only the energy of a consumer but also the focus and mood of the consumer. Therefore, the composition comprises at least one energy-enhancing ingredient (e.g., caffeine, methylliberine), at least one mood-enhancing ingredient (e.g., theanine), and at least one focus-enhancing ingredient (e.g., citicoline and/or alpha-GPC and uridine monophosphate). The composition may be free of “fillers,” such as taurine, choline bitartrate, and glucuronolactone. Related energy supplement drinks and other compositions are also disclosed.

### CROSS-REFERENCE TO RELATED APPLICATION

This application claims the benefit, under 35 U.S.C. § 119(e), of U.S. Provisional Patent Application Ser. No. 62/910,121, filed Oct. 3, 2019, the disclosure of which is hereby incorporated in its entirety herein by this reference.

### TECHNICAL FIELD

Embodiments of the present disclosure, in various embodiments, generally relate to supplement compositions for enhancing the energy of the consumer. More particularly, this disclosure relates to supplement compositions for enhancing the energy of the consumer as well as for enhancing the focus and mood of the consumer.

### BACKGROUND

Energy supplements, formulated to deliver an increased amount of energy to a consumer for a period of time (e.g., a few hours or more), have become popular in recent years. These energy supplements are often provided to consumers in the form of a relatively-small liquid drink (e.g., a “shot”). Such conventional energy supplements tend to address only the energy level of the consumer with many such energy supplements comprising primarily caffeine and little else of real benefit to the consumer. For example, many conventional energy supplements include filler ingredients, which may not necessarily provide any additional benefit to the consumer, in an effort to boast a great number of ingredients, despite the lack of additional functionality from the filler. Accordingly, conventional energy supplements tend to provide limited benefit to the consumer and lack a streamlined composition.

### BRIEF SUMMARY

Disclosed is a composition—for enhancing the energy, mood, and focus of a consumer of the composition—comprising at least one energy-enhancing ingredient, at least one mood-enhancing ingredient, and at least one focus-enhancing ingredient.

Also disclosed is a composition—for enhancing the energy, mood, and focus of a consumer of the composition—comprising caffeine, methylliberine, 1-theanine, citicoline, and uridine monophosphate.

Moreover, also disclosed is an energy supplement drink in a container, the drink comprising at least one energy-enhancing ingredient, at least one mood-enhancing ingredient, and at least one focus-enhancing ingredient. The at least one energy-enhancing ingredient is selected from the group consisting of caffeine, methylliberine, citrulline malate, and rauwolscine. The at least one mood-enhancing ingredient is selected from the group consisting of theanine, phenylalanine, tyrosine, and vitamin B6. The at least one focus-enhancing ingredient is selected from the group consisting of citicoline, alpha-GPC, uridine monophosphate, vitamin B3, and huperzine A.

### DETAILED DESCRIPTION

Embodiments of the present disclosure provide energy supplement compositions that provide not only enhanced energy for the consumer, but also enhanced focus and mood. Compositions of the disclosure may include a minimal number of ingredients, without non-functional “fillers.” At least one ingredient is formulated to enhance the consumer's energy, at least one ingredient is formulated to enhance the consumer's focus, and at least one ingredient is formulated to enhance the consumer's mood.

The energy supplement compositions of the disclosure may be provided in the form of a liquid drink, already pre-mixed with the ingredients discussed herein. Such a drink may be provided as a small-volume shot. As used herein, the term “small-volume shot” means and includes a liquid volume of less than or about eight ounces, e.g., about two ounces, about three ounces, about four ounces, about five ounces, etc. In other embodiments, a drink comprising the energy supplement composition may be in the form of a greater volume drink, such as at a volume of more than eight ounces, such as at twelve ounces, at sixteen ounces, etc. As used in this disclosure, “ounces” means and refers to fluid ounces, unless otherwise indicated. Any of the aforementioned drink forms may be provided to a consumer in a container, such as a can (e.g., an aluminum can) or a bottle.

Alternatively, the energy supplement composition may be provided in the form of a solid (e.g., a powder) with which a consumer may, him or herself, add a liquid (e.g., water) to form a consumable aqueous solution with the ingredients discussed herein.

Alternatively, the energy supplement composition may be provided in solid form (e.g., a powder) within a capsule to be swallowed by the consumer, the solid form (e.g., the powder) comprising the ingredients discussed herein.

Alternatively, the energy supplement composition may be provided in solid tablet form to be swallowed or chewed and swallowed by the consumer, with the tablet comprising the ingredients discussed herein.

### Energy-Enhancing Ingredient(s)

At least one of the ingredients of the energy supplement composition is formulated as an energy-enhancing ingredient. The at least one energy-enhancing ingredient may be selected from the group comprising or consisting of caffeine (e.g., caffeine anhydrous), methylliberine (e.g., DYNAMINE™, an ingredient—marketed by Compound Solutions of Carlsbad, Calif., USA—that is about 98% pure methylliberine), citrulline malate (e.g., citrulline malate (2:1)), and rauwolscine (e.g., rauwolfia serpentina extract).

In some embodiments, the energy supplement composition may comprise, as the at least one energy-enhancing ingredient, the caffeine (e.g., caffeine anhydrous) and the methylliberine. In such compositions, the methylliberine—a purine alkaloid that may be derived from kucha tea leaves—may enhance (e.g., synergistically enhance) the effects of the caffeine (e.g., the stimulant effects) without negative effects (e.g., negative effects of a stimulant). For example, in the presence of the methylliberine, the caffeine may be inhibited from negatively affecting the consumer's central nervous system. Therefore, including both such compounds in the focus-enhancing ingredients may provide a better energy-enhancing benefit to the consumer than including either such compound alone.

The at least one energy-enhancing ingredient may be a primary ingredient of the energy supplement composition. As used herein, the term “primary ingredient” means and includes an ingredient or group of ingredients composing at least 50 wt. % of the enhancing ingredients (e.g., the total weight of the energy-enhancing ingredient(s) plus the mood-enhancing ingredient(s) plus the focus-enhancing ingredient(s)) of the composition.

In some embodiments comprising caffeine in the at least one energy-enhancing ingredient(s), the caffeine may not, alone, be a primary ingredient of the energy supplement composition. Therefore, the energy supplement composition does not primarily caffeinate the consumer, but provides additional benefits, as discussed herein.

### Mood-Enhancing Ingredients

At least one of the ingredients of the energy supplement composition is formulated as a mood-enhancing ingredient. The at least one mood-enhancing ingredient may comprise, consist essentially of, or consist of one or more amino acids (e.g., phenylalanine, such as DL-phenylalanine; tyrosine, such as n-acetyl 1-tyrosine); theanine, such as 1-theanine) and/or one or more vitamins (e.g., vitamin B6 (pyridoxine HCL)).

The at least one mood-enhancing ingredient may be a secondary ingredient of the energy supplement composition. As used herein, the term “secondary ingredient” means and includes an ingredient or group of ingredients composing less than 50 wt. % of the enhancing ingredients composition and less than the weight percentage of a primary ingredient(s) but more of the weight percentage than other ingredients or groups of ingredients.

In some embodiments, the phenylalanine (e.g., DL-phenylalanine) may be a primary ingredient of the at least one mood-enhancing ingredient(s). Therefore, the phenylalanine (e.g., DL-phenylalanine) may compose at least about 50 wt. % of the mood-enhancing ingredient(s) of the enhancing ingredients composition.

### Focus-Enhancing Ingredients

At least one of the ingredients of the energy supplement composition is formulated as a focus-enhancing ingredient. The at least one focus-enhancing ingredient may comprise one or more nootropic ingredients, which may enhance memory, may enhance brain function, may enhance concentration, and/or may otherwise enhance focus. All of these brain-boosted effects are categorized herein as “focus-enhancing” effects.

The at least one focus-enhancing ingredient may be selected from the group comprising or consisting of citicoline (e.g., CDP choline) (also known as cytidine diphosphate-choline, cytidine 5′-diphosphochline, C₁₄H₂₇N₄O₁₁P₂+, and/or 5′O-[hydroxy({hydroxy[2-(trimethylammonio)ethoxy]phosphoryl}oxy)phosphoryl]cytidine); alpha-GPC (also known as 1-alpha glycerylphosphorylcholine, C₈H₂₀NO₆P); uridine monophosphate; niacin (e.g., vitamin B3); and huperzine A (e.g., huperzia serrata (leaf) extract).

In embodiments in which the focus-energy ingredients comprise, consist essentially of, or consist of citicoline and uridine monophosphate, the uridine monophosphate may enhance the focus-enhancing effects of the citicoline. Therefore, including both such compounds in the focus-enhancing ingredients may provide a greater focus-enhancing benefit to the consumer than including either such compound alone.

### Additional Ingredients

In addition to the aforementioned enhancing ingredients, the energy supplement composition may also comprise a base consumable liquid (e.g., water, such as purified water), flavorings (e.g., natural favoring, artificial flavoring, or both), sweeteners (e.g., sucralose), and/or preservatives (e.g., sodium benzoate, potassium sorbate).

In some embodiments, the energy supplement composition may also comprise malic acid as an additional ingredient.

### Fillers

To keep the energy supplement composition simplified and aimed at benefit-providing ingredients, conventional “filler” ingredients may, in some embodiments, be intentionally excluded. Such excluded filler ingredients may include one, more than one, or all of the following: malic acid, taurine, choline bitartrate, and/or glucuronolactone (also known as glucuronic acid lactone, glucurone, glucurolactone, d-glucurono-gamma-lactone).

Malic acid may be excluded, e.g., because it may not provide an enhancement to the energy of the consumer. Taurine may be excluded because, e.g., as a central nervous systems depressant, it may not contribute to the enhancement of energy of the consumer. Choline bitartrate may be excluded because, e.g., it may not cross the consumer's blood-brain barrier and so may not provide a benefit to the consumer if included in the composition. Glucuronolactone, commonly touted as a detoxifier, may be excluded because, e.g., the ordinary diet intake of carbohydrates by a consumer in a developed nation may already provide sufficient detoxifying effects such that additional glucuronolactone in the composition may provide no significant benefit to the consumer.

Though the aforementioned “fillers” may be intentionally excluded from some embodiments of the disclosed energy supplement compositions, in other embodiments, one, more than one, or all of these may be included. For example, in some embodiments, one or more of the “fillers” may be included in a minor amount (e.g., less than 1 wt. % of the total weight of the enhancing ingredients).

### Examples

Following are particular, nonlimiting examples of the energy supplement compositions of this disclosure.

A composition comprising, consisting essentially of, or consisting of:
at least one energy-enhancing ingredient, comprising:
   caffeine (e.g., caffeine anhydrous); and
   methylliberine (e.g., DYNAMINE™);
at least one mood-enhancing ingredient, comprising:
   l-theanine; and
at least one focus-enhancing ingredient, comprising:
   at least one of citicoline and alpha-GPC; and
   uridine monophosphate.

A composition comprising, consisting essentially of, or consisting of:
at least one energy-enhancing ingredient, comprising:
   250 mg to 350 mg caffeine (e.g., caffeine anhydrous);
   80 mg to 140 mg methylliberine (e.g., DYNAMINE™); and
   500 mcg to 1.5 mg rauwolscine (e.g., rauwolfia serpentina extract);
at least one mood-enhancing ingredient, comprising:
   60 mg to 150 mg l-theanine; and
at least one focus-enhancing ingredient, comprising:
   80 mg to 140 mg citicoline (or, alternatively alpha-GPC);
   50 mg to 100 mg uridine monophosphate; and
   100 mcg to 300 mcg huperzine A (e.g., huperzia serrata (leaf) extract).

A supplement composition comprising, consisting essentially of, or consisting of:
at least one energy-enhancing ingredient, comprising, consisting essentially of, or consisting of:
   caffeine (e.g., caffeine anhydrous);
   methylliberine (e.g., DYNAMINE™);
   citrulline malate (2:1); and
   rauwolscine (e.g., rauwolfia serpentina extract);
at least one mood-enhancing ingredient, comprising:
   theanine (e.g., l-theanine);
   phenylalanine (e.g., dl-phenylalanine);
   tyrosine (e.g., n-acetyl l-tyrosine); and
   vitamin B6 (pyridoxine hydrochloride);
at least one focus-enhancing ingredient, comprising:
   citicoline (e.g., CDP choline) or alpha-GPC or both;
   uridine monophosphate;
   vitamin B3 (niacin); and
   huperzine A (e.g., huperzia serrata (leaf) extract).

A small-volume shot in a container, the composition of the small-volume shot comprising, consisting essentially of, or consisting of:
at least one energy-enhancing ingredient at at least about 50 wt. % (e.g., about 64 wt. %) of the enhancing ingredients of the composition;
at least one mood-enhancing ingredient at at least about 25 wt. % (e.g., about 28 wt. %) of the enhancing ingredients of the composition; and
at least one focus-enhancing ingredient at at least about 5 wt. % (e.g., about 8 wt. %) of the enhancing ingredients of the composition.

A small-volume shot in a container, the composition of the small-volume shot comprising, consisting essentially of, or consisting of:
at least one energy-enhancing ingredient at at least about 50 wt. % (e.g., about 60 wt. %) of the enhancing ingredients of the composition;
at least one mood-enhancing ingredient at at least about 25 wt. % (e.g., about 33 wt. %) of the enhancing ingredients of the composition; and
at least one focus-enhancing ingredient at at least about 5 wt. % (e.g., about 7 wt. %) of the enhancing ingredients of the composition.

A small-volume shot of two fluid ounces in a container, the composition of the small-volume shot comprising, consisting essentially of, or consisting of:
at least one energy-enhancing ingredient (e.g., 1381 mg), comprising, consisting essentially of, or consisting of:
   caffeine (e.g., caffeine anhydrous) (e.g., 280 mg);
   methylliberine (e.g., DYNAMINE™) (e.g., 100 mg);
   citrulline malate (2:1) (e.g., 1000 mg); and
   rauwolscine (e.g., rauwolfia serpentina extract) (e.g., 800 mcg);
at least one mood-enhancing ingredient (e.g., 605 mg), comprising, consisting essentially of, or consisting of:
   theanine (e.g., l-theanine) (e.g., 90 mg);
   phenylalanine (e.g., dl-phenylalanine) (e.g., 250 mg);
   tyrosine (e.g., n-acetyl l-tyrosine) (e.g., 250 mg); and
   vitamin B6 (pyridoxine hydrochloride) (e.g., 15 mg); and
at least one focus-enhancing ingredient (e.g., 165 mg), comprising, consisting essentially of, or consisting of:
   citicoline (e.g., CDP choline) (e.g., 100 mg);
   uridine monophosphate (e.g., 50 mg);
   vitamin B3 (niacin) (e.g., 16 mg); and
   huperzine A (e.g., huperzia serrata (leaf) extract) (e.g., 150 mcg).

A small-volume shot of two fluid ounces in a container, the composition of the small-volume shot comprising, consisting essentially of, or consisting of:
at least one energy-enhancing ingredient (e.g., 1381 mg), comprising, consisting essentially of, or consisting of:
   caffeine (e.g., caffeine anhydrous) (e.g., 280 mg);
   methylliberine (e.g., DYNAMINE™) (e.g., 100 mg);
   citrulline malate (2:1) (e.g., 1000 mg); and
   rauwolscine (e.g., rauwolfia serpentina extract) (e.g., 1.5 mg);
at least one mood-enhancing ingredient (e.g., 755 mg), comprising, consisting essentially of, or consisting of:
   theanine (e.g., l-theanine) (e.g., 90 mg);
   phenylalanine (e.g., dl-phenylalanine) (e.g., 400 mg);
   tyrosine (e.g., n-acetyl l-tyrosine) (e.g., 250 mg); and
   vitamin B6 (pyridoxine hydrochloride) (e.g., 15 mg); and
at least one focus-enhancing ingredient (e.g., 165 mg), comprising, consisting essentially of, or consisting of:
   citicoline (e.g., CDP choline) (e.g., 100 mg);
   uridine monophosphate (e.g., 50 mg);
   vitamin B3 (niacin) (e.g., 16 mg); and
   huperzine A (e.g., 150 mcg).

In embodiments in which the composition comprises, e.g., the 100 mg of methylliberine (e.g., DYNAMINE™), the methylliberine may enhance the effects of the caffeine by about two fold. Accordingly, the inclusion of both the 100 mg of methylliberine with the caffeine—in the at least one energy-enhancing ingredient—may exhibit a surprising synergistic energy-enhancing effect for the consumer.

In the above-discussed examples and other embodiments, the disclosed amounts of “huperzine A” are amounts of substantially pure (e.g., at least 90% pure huperzine A (e.g., huperzia serrata (leaf) extract), as opposed to a “huperzine A” ingredient comprising only a minor percentage of active huperzine A (e.g., a minor percentage huperzia serrata extract).

In another example, the composition may comprise, consist essentially of, or consist of the composition of the small-volume shot of the preceding example, but with alpha-GCP instead of the citicoline.

In any of the aforementioned examples for the composition, the composition may be in the form of a liquid drink to be consumed by a consumer, in the form of a solid (e.g., powder) to be mixed into a liquid drink to be consumed by the consumer, or in the form of a capsule or tablet to be consumed by the consumer.

In any of the aforementioned examples for the composition, the composition be free of one, more than one, or all of the following “fillers”:
malic acid;
taurine;
choline bitartrate; and
glucuronolactone.

In any of the aforementioned examples, the composition may further—in addition to the enhancing ingredients—comprise, consist essentially of, or consist of one, more than one, or all of the following “additional ingredients”:
water (e.g., purified water);
flavoring ingredient(s) (e.g., natural flavoring ingredients, artificial flavoring ingredients, or both);
sweetener(s) (e.g., sucralose); and
preservatives(s) (e.g., sodium benzoate, potassium sorbate).

In other embodiments, the additional ingredients of the preceding example may also comprise malic acid. Such composition may nonetheless exclude the other “fillers” listed above.

While the disclosed compositions are susceptible to various modifications and alternative forms in implementation thereof, specific embodiments have been described in detail herein. However, it should be understood that the present invention is not intended to be limited to the particular forms disclosed. Rather, the present invention encompasses all modifications, combinations, equivalents, variations, and alternatives falling within the scope of the present disclosure as defined by the following appended claims and their legal equivalents.

What is claimed is:

1. A composition for enhancing the energy, mood, and focus of a consumer of the composition, the composition comprising:
at least one energy-enhancing ingredient;
at least one mood-enhancing ingredient; and
at least one focus-enhancing ingredient.

2. The composition of claim 1, wherein the at least one energy-enhancing ingredient comprises:
caffeine; and
methylliberine.

3. The composition of claim 1, wherein the at least one mood-enhancing ingredient comprises theanine.

4. The composition of claim 1, wherein the at least one focus-enhancing ingredient comprises at least one of citicoline or alpha-GPC.

5. The composition of claim 4, wherein the at least one focus-enhancing ingredient further comprises uridine monophosphate.

6. The composition of claim 1, wherein the composition is a liquid drink form.

7. The composition of claim 1, wherein the composition is in powder form.

8. The composition of claim 1, wherein:
the at least one energy-enhancing ingredient comprises caffeine; and
the caffeine composes less than 50 wt. % of a total combined weight of the at least one energy-enhancing ingredient, the at least one mood-enhancing ingredient, and the at least one focus-enhancing ingredient.

9. The composition of claim 1, wherein the composition is free of taurine, choline bitartrate, and glucuronolactone.

10. The composition of claim 1, wherein the composition is free of malic acid.

11. The composition of claim 1, wherein:
the at least one energy-enhancing ingredient composes at least about 50 wt. % of a total combined weight of the at least one energy-enhancing ingredient, the at least one mood-enhancing ingredient, and the at least one focus-enhancing ingredient;
the at least one mood-enhancing ingredient composes at least about 25 wt. % of the total combined weight; and
the at least one focus-enhancing ingredient composes at least about 5 wt. % of the total combined weight.

12. The composition of claim 1, wherein:
the at least one energy-enhancing ingredient composes about 60 wt. % of a total combined weight of the at least one energy-enhancing ingredient, the at least one mood-enhancing ingredient, and the at least one focus-enhancing ingredient;
the at least one mood-enhancing ingredient composes about 33 wt. % of the total combined weight; and
the at least one focus-enhancing ingredient composes about 7 wt. % of the total combined weight.

13. The composition of claim 1, wherein the at least one energy-enhancing ingredient comprises caffeine and about 100 mg methylliberine.

14. A composition for enhancing the energy, mood, and focus of a consumer of the composition, the composition comprising: caffeine, methylliberine, 1-theanine, citicoline, and uridine monophosphate.

15. The composition of claim 14, further comprising rauwolscine.

16. The composition of claim 14, further comprising huperzine A.

17. An energy supplement drink in a container, the drink comprising:
at least one energy-enhancing ingredient selected from the group consisting of caffeine, methylliberine, citrulline malate, and rauwolscine;
at least one mood-enhancing ingredient selected from the group consisting of theanine, phenylalanine, tyrosine, and vitamin B6; and
at least one focus-enhancing ingredient selected from the group consisting of citicoline, alpha-GPC, uridine monophosphate, vitamin B3, and huperzine A.

18. The energy supplement drink of claim 17, wherein the container consists of about two fluid ounces of the drink.

19. The energy supplement drink of claim 17, wherein the container comprises more than about eight fluid ounces of the drink.

20. The energy supplement drink of claim 17, wherein the drink does not comprise any of taurine, choline bitartrate, glucuronolactone, and malic acid.
